(19) United States
(12) Patent Application Publication
(10) Pub. No.: US 2023/0198113 A1
(43) Pub. Date: Jun. 22, 2023

(54) STUB TUNER

(71) Applicant: FURUNO ELECTRIC CO., LTD., Hyogo (JP)

(72) Inventors: Kazuyoshi FUJISAKI, Hyogo (JP); Mitsuhiko Hataya, Hyogo (JP)

(73) Assignee: FURUNO ELECTRIC CO., LTD., Hyogo (JP)

(21) Appl. No.: 18/173,750

(22) Filed: Feb. 23, 2023

Related U.S. Application Data
(63) Continuation of application No. PCT/JP2021/033884, filed on Sep. 15, 2021.

(30) Foreign Application Priority Data
Oct. 15, 2020 (JP) 2020-173720

(51) Int. Cl. H01P 1/00; H01P 3/12

(52) U.S. Cl. CPC H01P 1/00; H01P 3/12

(57) ABSTRACT

A stub tuner includes a first conductor, and a rod-shaped conductor shaft. The first conductor is inserted into a tube axial direction inner side from an opening in a waveguide tube transmitting high frequency waves. The first conductor includes a plate-shaped first shape extending in a direction intersecting a tube axial direction, inside the waveguide tube, and a plate-shaped second shape extending from the outer end in the tube radial direction of the first shape toward the tube axial direction outer side in the tube axial direction. An outer circumferential surface of the second shape is separated from an inner surface of the waveguide tube. An electrical length of the outer circumferential surface in the tube axial direction is ¼ of a wavelength of the high-frequency waves. The conductor shaft is electrically connected to the waveguide tube, supports the first conductor, and extends in the tube axial direction.

### CROSS-REFERENCE TO RELATED APPLICATION

The present application is a continuation of PCT/JP2021/033884, filed on Sep. 15, 2021, and is related to and claims priority from Japanese patent application no. 2020-173720, filed on Oct. 15, 2020. The entire contents of the aforementioned applications are hereby incorporated by reference herein.

### TECHNICAL FIELD

The disclosure relates to a stub tuner inserted into a waveguide tube that transmits high frequency waves.

### RELATED ART

A waveguide tube is used as a radio wave transmission path in a device using high frequency waves (e.g., microwaves), such as a weather radar. At a connection portion between the waveguide tube and another transmission path or a connection portion between the waveguide tube and an apparatus, a transmission path non-conformity may occur intentionally or unintentionally. Such non-conformity is referred to as a mismatch. Since a mismatch adversely affects the transmission path, it is necessary to perform impedance adjustment to suppress the reflection or leakage of high frequency waves from a mismatch part, and a stub tuner is provided in the waveguide tube.

For example, while not a weather radar, Patent Document 1 (Japanese Laid-open No. H08078914) discloses a stub tuner slidably movable in a direction orthogonal to a tube axial direction of a waveguide tube.

While not a weather radar, FIG. 2 of Patent Document 2 (WO2016/135899) discloses a short plunger (106) disposed in a rectangular waveguide tube (101). A gap is shown between the short plunger (106) and the rectangular waveguide tube (101), and a possibility that radio waves may leak from the axial direction end of the waveguide tube through such gap is considered.

While not a weather radar, Patent Document 3 (Japanese Laid-open No. 2010-168684) discloses a movable plunger 34 having a conductive surface for reflecting microwaves. A gap is shown between the movable plunger 34 and a waveguide tube, and a possibility that radio waves may leak from the axial direction end of the waveguide tube through such gap is considered.

### SUMMARY

A stub tuner according to the disclosure may include a first conductor and a conductor shaft. The first conductor is inserted from an opening of a waveguide tube transmitting high frequency waves to a tube axial direction inner side and includes a first shape and a second shape. The first shape is a plate shape extending in a direction intersecting with the tube axial direction in the waveguide tube. The second shape is a plate shape extending along the tube axial direction from a tube axial direction outer end of the first shape toward a tube axial direction outer side. An outer circumferential surface of the second shape is separated from an inner surface of the waveguide tube, and an electrical length along the tube axial direction on the outer circumferential surface of the second shape is ¼ of a wavelength of the high frequency waves. The conductor shaft has a rod shape, is electrically connected to the waveguide tube, supports the first conductor, and extends in the tube axial direction.

According to an embodiment, in the first conductor, a distance between an inner circumferential surface of the second shape and an outer circumferential surface of the conductor shaft may be greater than a distance between the outer circumferential surface of the second shape and the inner surface of the waveguide tube.

According to an embodiment, the stub tuner may include a support member provided at the conductor shaft on an opening side of the waveguide tube with respect to the first conductor, and contacting an inner surface of the waveguide tube to pass through the conductor shaft to support the first conductor.

According to an embodiment, in a cross-section where the first conductor is present, the conductor shaft may be located at a center of a pair of the second shapes. The support member may be formed by a conductor and electrically connected to the conductor tube. In the first conductor and the conductor shaft, an electrical length along component surfaces from an intersection point P3 with the support member on an outer circumferential surface of the conductor shaft to a tube axial direction outer end P6 of an inner circumferential surface of the second shape through an intersection point P4 with a tube axial direction outer side surface of the first shape on an outer circumferential surface of the conductor shaft and an intersection point P5 with the inner circumferential surface of the second shape on the tube axial direction outer side surface of the first shape may be ¾ of the wavelength of the high frequency waves.

According to an embodiment, an insulating layer may be provided on the outer circumferential surface of the second shape.

According to an embodiment, the waveguide tube may be a rectangular waveguide tube in which a tube cross-sectional surface has long sides and short sides. The second shape may be a shape of a pair of plates respectively extending from a tube axial direction outer end of the first shape toward the opening along the tube axial direction, and the shape of the pair of plates may face at least a portion of the inner surface on the long sides of the waveguide tube.

According to an embodiment, in a cross-section passing through central portions of the long sides and a tube axis, the first conductor may be in a U shape.

According to an embodiment, the waveguide tube may be a circular waveguide tube in which a tube cross-sectional surface is circular, and the second shape may be formed to be line symmetric with the conductor shaft as an axis of symmetry.

### BRIEF DESCRIPTION OF DRAWINGS

FIG. 1 is a cross-sectional view of a II-II portion in FIG. 3, and illustrating a stub tuner and a waveguide tube according to a first embodiment.

FIG. 2 is an enlarged cross-sectional view of the II-II portion in FIG. 3, in which main components of FIG. 1 are enlarged.

FIG. 3 is a perspective view illustrating the stub tuner and the waveguide tube according to the first embodiment.

FIG. 4 is a schematic cross-sectional view orthogonal to a tube axis at a portion in which an oscillating electric field is strong in a tube axis direction.

FIG. 5 is a view relating to a transmission path between an inner surface of the waveguide tube and an outer circumferential surface of a second shape.

FIG. 6 is a view relating to a transmission path between a first conductor and a conductor shaft.

FIG. 7 is a view illustrating an assembly of components forming the stub tuner.

FIG. 8 is a cross-sectional view of a VIII-VIII portion in FIG. 2.

FIG. 9 is a cross-sectional view illustrating a modified example of the first embodiment.

FIG. 10 is a perspective view illustrating a stub tuner and a waveguide tube according to a second embodiment.

### DESCRIPTION OF EMBODIMENTS

The disclosure provides a stub tuner which prevents leakage of radio waves from an opening in a tube axial direction end portion of a waveguide tube.

### First Embodiment

In the following, a stub tuner according to the first embodiment of the disclosure is described with reference to the drawings.

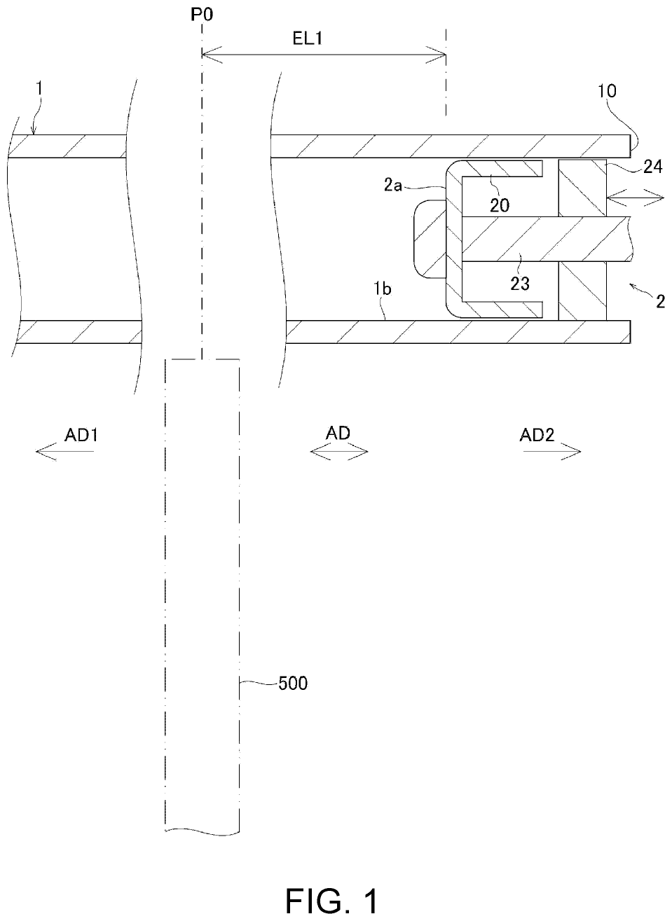

As shown in FIGS. 1 to 3, a stub tuner 2 of the first embodiment is inserted into a tube axial direction inner side AD1 from an opening 10 of a waveguide tube 1 which transmits high frequency waves. The waveguide tube 1 is a hollow metal tube, and is formed by using a conductor. The waveguide tube 1 is electrically shorted and set to be grounded. The high frequency waves travel in the waveguide tube 1 from the tube axial direction inner side AD1 toward a tube axial direction outer side AD2. “High frequency waves” in the specification may refer to radio waves of 300 MHz or higher, radio waves of 2 GHz or higher, or radio waves of 3 GHz or higher. Also, as an upper limit value, the high frequency waves may be radio waves of 50 GHz or lower, for example. As the upper limit value, the high frequency waves may also be radio waves of 40 GHz or lower, for example. The high frequency waves may also be microwaves or millimeter waves. Although aluminum or stainless steel is used as the conductor in the embodiment, the disclosure is not limited thereto as long as the conductor is conductive.

The stub tuner 2 is configured to be slidably movable in a tube axial direction AD of the waveguide tube 1. Accordingly, as shown in FIG. 1, the position of the stub tuner 2 in the tube axial direction AD in the waveguide tube 1 is changeable, and an electrical length EL1 from a particular position P0 (see FIG. 1) in the waveguide tube 1 to a tip part 2a of the stub tuner 2 is adjustable. As an example, another transmission path 500 or an apparatus may be connected to the particular position P0.

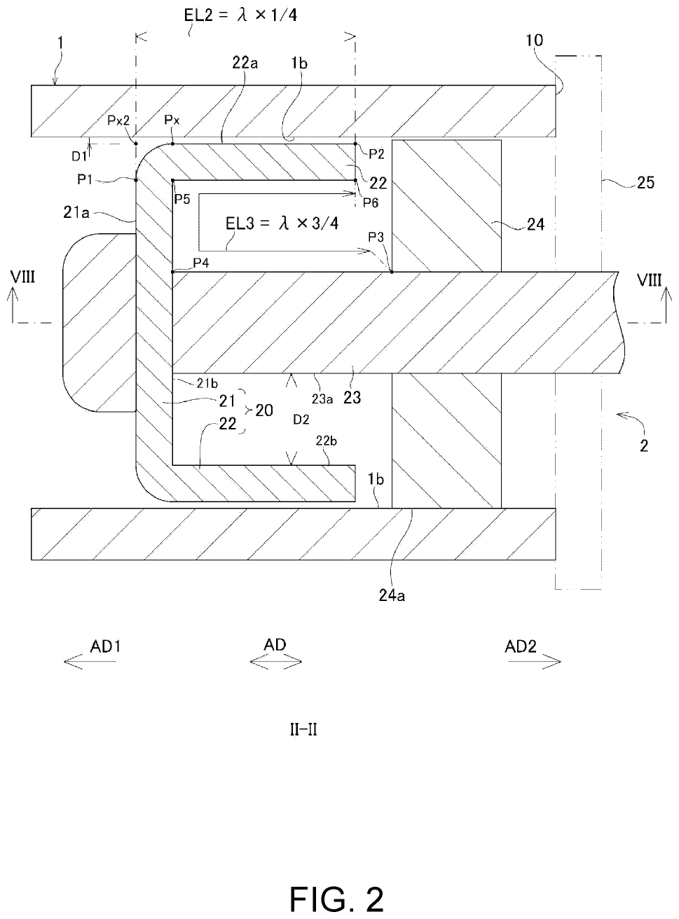

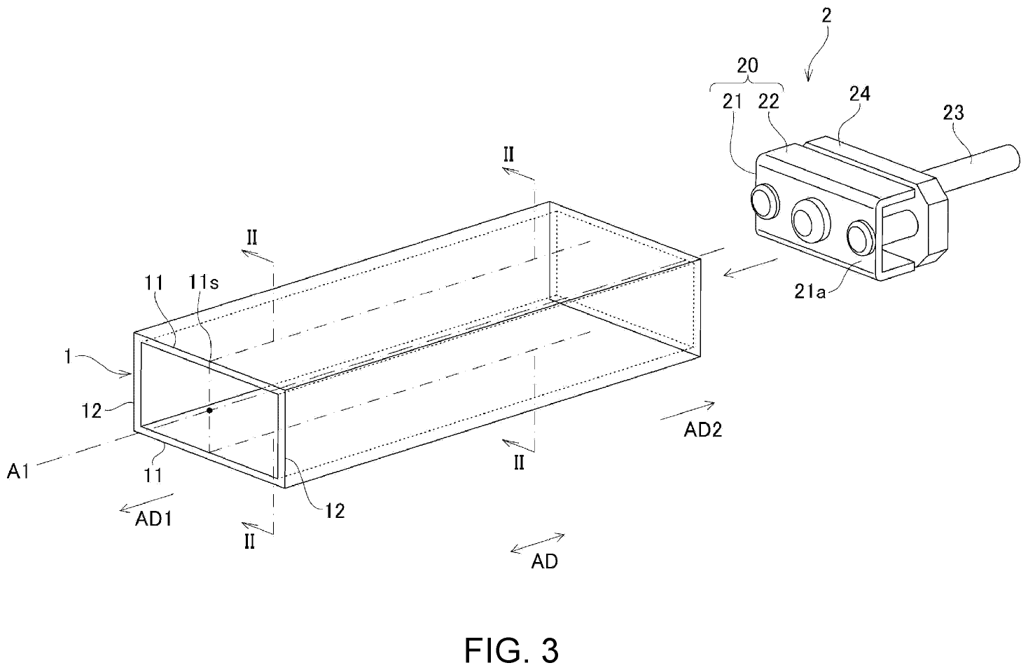

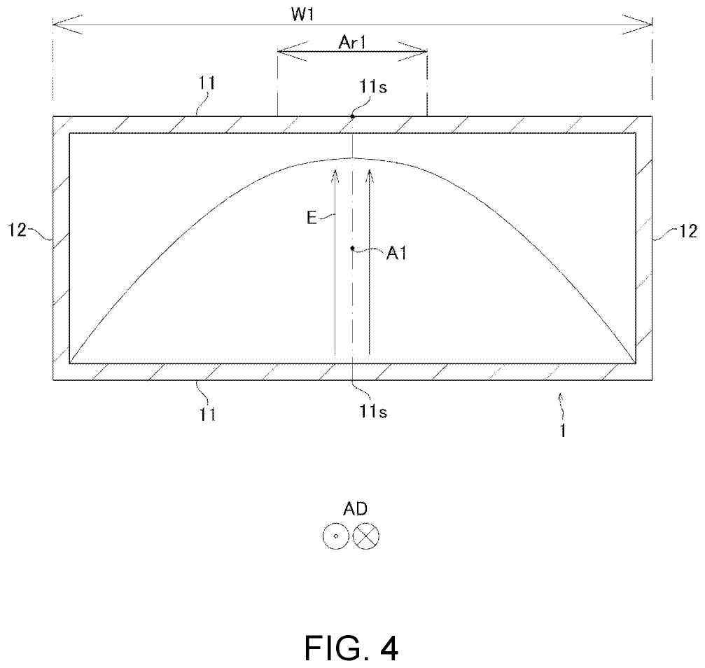

As shown in FIG. 3, the waveguide tube 1 of the first embodiment is a rectangular waveguide tube 1 in which a tube cross-section has long sides 11 and short sides 12. The long sides 11 are parallel to each other, and the short sides 12 are parallel to each other. FIGS. 1 and 2 are cross-sectional views of a II-II portion in FIG. 3. The cross-sectional views of the II-II portion illustrate a cross-section passing through centers 11s of the long sides 11 (also referred to as central portions 11s of the long sides 11) and a tube axis A1. In the waveguide tube 1, an oscillating electric field is generated due to traveling waves and reflected waves. FIG. 4 is a schematic cross-sectional view orthogonal to the tube axis A1 at a portion in which the oscillating electric field is strong in the tube axis direction AD. As shown in the same figure, an oscillating electric field E becomes the antinode at the portion connecting the centers 11s of the long sides 11 and becomes the most dominant. Meanwhile, at the short sides 12, the oscillating electric field E is not generated. The high frequency waves are transmitted in the waveguide tube 1 in a transverse electric (TE) 10 mode, which is a fundamental mode of such rectangular waveguide tube 1. In the TE10 mode, the electric field is not generated in a direction parallel to the long sides 11, but is generated in a direction parallel to the short sides 12. It is noted that, the disclosure is not limited thereto in a mode other than the fundamental mode (TE10 mode), and a mode other than TE10 may also be used.

As shown in FIGS. 1 to 3, the stub tuner 2 has a first conductor 20 and a conductor shaft 23 having a rod shape, supporting the first conductor 20, and extending in the tube axial direction AD. The conductor shaft 23 is electrically connected to the waveguide tube 1. Accordingly, the first conductor 20 is electrically connected to the waveguide tube 1 via the conductor shaft 23. As shown in FIGS. 2 and 3, the first conductor 20 has a first shape 21 of a plate shape and a second shape 22 of a plate shape. The first shape 21 extends in a direction intersecting with the tube axial direction AD in the waveguide tube 1. The first shape 21 forms a reflective surface 21a blocking the waveguide tube 1 to reflect the high frequency waves. Although the first shape 21 blocks the waveguide tube 1, the first shape 21 does not contact the inner surface of the waveguide tube 1 and a gap is formed. Although the first shape 21 in the embodiment extends in a direction orthogonal to the tube axial direction AD, the disclosure is not limited thereto, as long as the first shape 21 extends in a direction intersecting with the tube axial direction AD.

As shown in FIG. 2, the second shape 22 extends from a tube radial direction outer end of the first shape 21 toward the tube axial direction outer side AD2 along the tube axial direction AD. An outer circumferential surface 22a of the second shape 22 is separated from an inner surface 1b of the waveguide tube 1. In the embodiment, regarding the first conductor 20, two ends of a plate member are bent, the central portion is configured as the first shape 21, a pair of bent plate-shaped portions are configured as the second shapes 22, and the first conductor 20 is formed to exhibit a U-shaped cross-section. As shown in FIG. 3, the second shapes 22 with the shape of a pair of plates faces at least a portion of the inner surface 1b on the long side 11 of the waveguide tube 1. Since the oscillating electric field is the most dominant between the centers 11s of the long sides 11, as shown in FIG. 4, the second shapes 22 may face the centers 11s of the long sides 11 and the vicinities thereof. Specifically, the second shape 22 may face at least a region Ar1 that is 24% of a maximum width W1 of the long side 11 and centers on the center 11s of the long side 11. This is because 60% of power is distributed in the region Ar1 of 24%. In addition, the second shape 22 may face at least a region Ar1 that is 36% of the maximum width W1 of the long side 11 and centers on the center 11s of the long side 11. This is because 81% of power is distributed in the region Ar1 of 36%. Of course, the second shape 22 may also face the entire inner surface 1b on the long side 11.

As shown in FIG. 2, although the high frequency waves arriving toward the tube axial direction outer side AD2 are mostly reflected by the reflective surface 21a, the high frequency waves may enter the gap between the second shape 22 and the inner surface 1b of the waveguide tube 1 and leak from the opening of the waveguide tube 1. In order to suppress the entry of the high frequency waves, a configuration as follows is adopted.

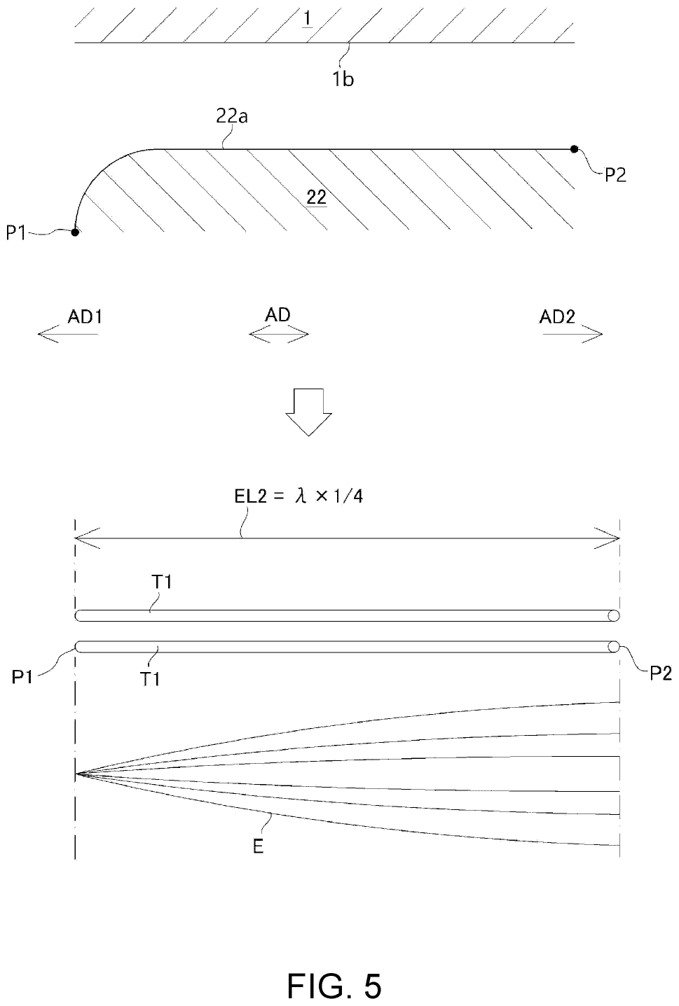

As shown in FIG. 2, an electrical length EL2 of the outer circumferential surface 22a of the second shape in the tube axial direction AD is ¼ of a wavelength λ of the high frequency waves. It suffices as long as the electrical length EL2 is ¼ of the wavelength λ of the high-frequency waves, with a tube axial direction outer end surface (a surface from P2 to P6) of the outer circumferential surface 22a of the second shape 22 as the starting point. Accordingly, as schematically shown in FIG. 5, a transmission path formed by the metal skin between the inner surface 1b of the waveguide tube 1 and the outer circumferential surface 22a of the second shape 22 can be considered as equivalent to a transmission path T1 with an open end. The electrical length EL2 of the transmission path T1 is ¼ of the wavelength λ of the high-frequency waves. Due to the traveling waves and reflected waves on the transmission path T1, the oscillating electric field E is generated in the waveguide tube 1. At a tube axial direction outer end P2 on the outer circumferential surface 22a of the second shape 22, the oscillating electric field E becomes an antinode (open). Meanwhile, at a tube axial direction inner end P1 on the outer circumferential surface 22a of the second shape 22, the oscillating electric field E becomes a node (short). As shown in FIG. 2, the oscillating electric field E may become short at a tube axial direction inner side end part (having a particular range) on the outer circumferential surface 22a of the second shape 22. Specifically, the oscillating electric field E may become short in a space from the position P1 to a position Px. In the embodiment, in order for the reflective surface 21a to function strongly as a short plate, the electrical length EL2 of a hypothetical line connecting the position P2 from a position Px2 is set as ¼ of the wavelength λ. However, it may also be that the electrical length EL2 of a hypothetical line connecting the position P2 from the position Px is set as ¼ of the wavelength λ.

As shown in FIG. 2, in the first conductor 20, a distance D2 between the inner circumferential surface 22b of the second shape 22 and an outer circumferential surface 23a of the conductor shaft 23 may be longer than a distance D1 between the outer circumferential surface 22a of the second shape 22 and the inner surface 1b of the waveguide tube 1. The performance as a short stub is facilitated. In addition, it is possible to suppress the occurrence of an anomaly that discharge occurs between the second shape and the conductor shaft 23. In particular, since discharge may occur at a high output (60 kW) of a magnetron with a high power at a moment, discharge is prevented effectively. The distance D2 may be 1 mm or more.

As shown in FIGS. 1 to 3, the stab tuner 2 has a support member 24. The support member 24 is provided at the conductor shaft 23 on the side of the opening 10 of the waveguide tube 1 with respect to the first conductor 20. The support member 24 contacts the inner surface 1b of the waveguide tube 1 and supports the first conductor 24 through the conductor shaft 23. It is possible to change the position of the first conductor 20 in the tube axial direction AD while bringing the support member 24 into contact with the inner surface 1b of the waveguide tube 1. The support member 24 may be a conductor or not a conductor, as long as the support member 24 provides support. Although the support member 24 extends in a direction intersecting with the tube axial direction AD and is formed in a plate shape as a whole, the shape is not limited thereto. If the support function is not required, the support member 24 may be omitted.

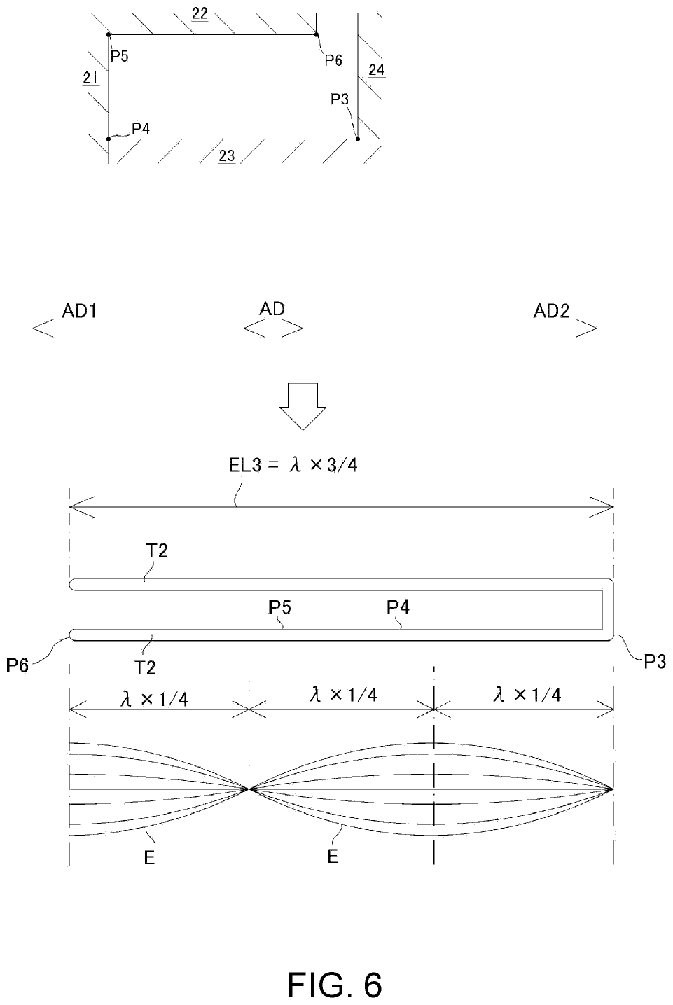

In the embodiment, in the cross-section (see FIG. 2) where the first conductor 20 is present, the conductor shaft 23 is located at the center of the pair of second shapes 22. In addition, the support member 24 is formed as a conductor and electrically connected to the waveguide tube 1 via a contact part 24a. A path for electrically connecting the first conductor 20 and the waveguide tube 1 may be arranged via the support member 24, and may also be arranged via an adjustment knob 25 to be described afterwards. As shown in FIG. 2, a space is formed between the first conductor 20 and the conductor shaft 23. In FIG. 2, an intersection point with the support member 24 on the outer circumferential surface 23a of the conductor shaft 23 is represented as P3. An intersection point with a tube axial direction outer side surface 21b of the first shape 21 on the outer circumferential surface 23a of the conductor shaft 23 is represented as P4. An intersection point with the inner circumferential surface 22b of the second shape 22 on the tube axial direction outer side surface 21b of the first shape 21 is represented as P5. A tube axial direction outer end of the inner circumferential surface 22b of the second shape 22 is represented as P6. In the first conductor 20 and the conductor shaft 23, an electrical length EL3 along component surfaces from the intersection point P3 to the tube axial direction outer end P6 through the intersection points P4 and P5 may be ¾ of the wavelength λ of the high frequency waves. Accordingly, as schematically shown in FIG. 6, since the support member 24 is a conductor and electrically connected with the waveguide tube 1, it can be considered that a transmission path formed by the metal skin between the first conductor 20 and the conductor shaft 23 is equivalent to the transmissions path T2 short-circuited at the end. At the intersection point P3 with the support member 24 on the outer circumferential surface 23a of the conductor shaft 23, the oscillating electric field E becomes a node (short). Meanwhile, at the tube axial direction outer end P6 on the inner circumferential surface 22b of the second shape 22, the oscillating electric field E becomes an antinode (open). By doing so, as shown in FIG. 2, in each of the transmission paths formed on the outer circumferential surface 22a and the inner circumferential surface 22b of the second shape 22, the oscillating electric field E becomes an antinode at the tube axial direction outer end (P2, P6) of the second shape 22.

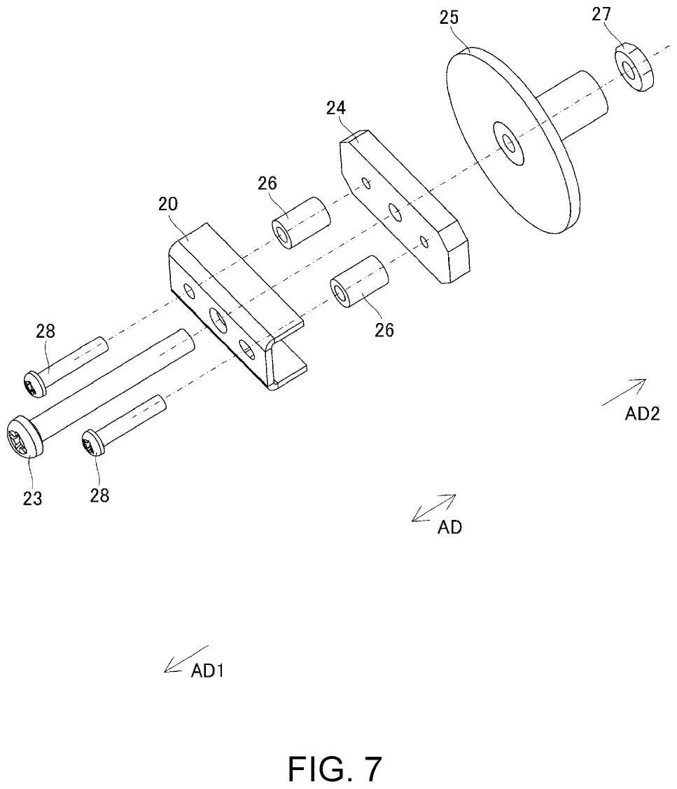

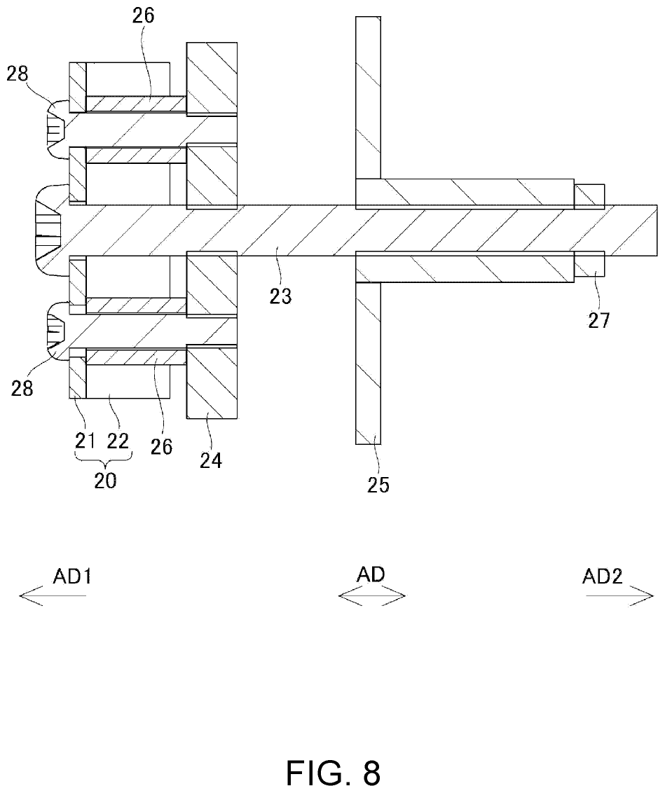

The stub tuner 2 can be assembled as shown in FIGS. 7 and 8. As shown in FIGS. 7 and 8, in the first conductor 20 with a U-shaped cross-section, three non-grooved bolt holes are formed, and in the plate-shaped support member 24, three corresponding grooved bolt holes are formed. Two headed bolts 28 are respectively inserted into the bolt holes of the first conductor 20 and hollow cylindrical spacers 26, and fastened to the grooved bolt holes of the support member 24. The conductor shaft 23 is a headed bolt. The conductor shaft 23 is inserted into the bolt hole of the first conductor 20 and fastened to the grooved bolt hole of the support member 24. Accordingly, the position relationship between the first conductor 20 and the support member 24 is fixed. The conductor shaft 23 is further inserted into a threaded bolt of the adjustment knob 25, and a nut 27 is attached to the tip end. The adjustment knob 25 is associated with the opening 10 of the waveguide tube 1. By rotating the adjustment knob 25, the first conductor 20 advances/treats to configure the position of the first conductor 20 in the tube axial direction AD to be adjustable. In the case where the reflective surface 23a of the embodiment is set as short in the embodiment, the electric field becomes zero in all of the upper portion, the intermediate portion, and the lower portion of the waveguide tube 1. Therefore, the presence/absence of the head constituting the conductor shaft 23 does not affect the performance. Although a headed bolt is used in the embodiment, the disclosure is not limited thereto. In place of the headed bolt, a headless bolt (a fully threaded bolt or a half-threaded bolt with threads on both ends) and a nut may also be adopted.

[Modified Example of First Embodiment]

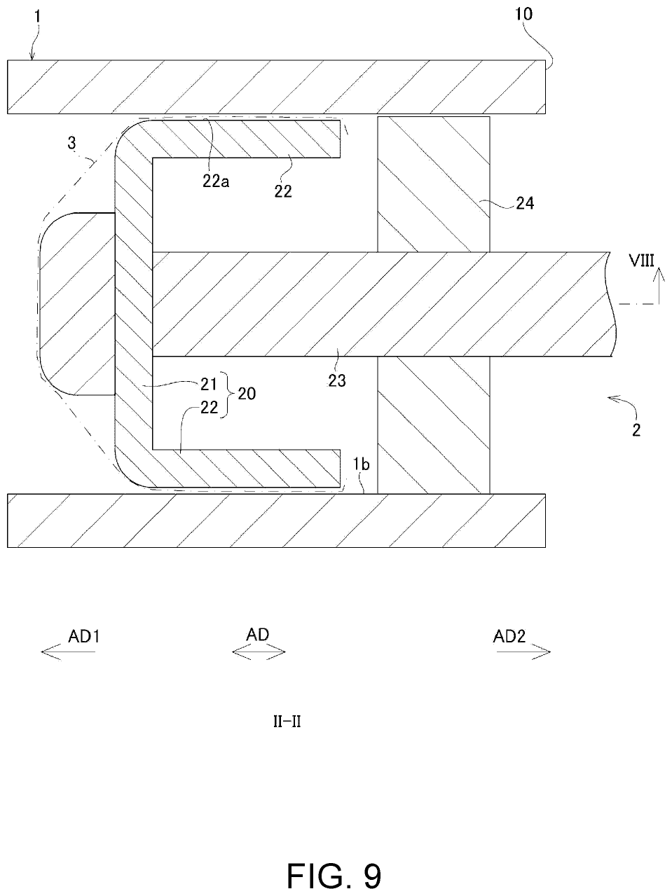

FIG. 9 illustrates a modified example of the first embodiment shown in FIGS. 1 to 8. In the stub tuner 2 according to the modified example of the first embodiment shown in FIG. 9, an insulating layer 3 is provided on the outer circumferential surface 22a of the second shape 22. With the presence of the insulating layer 3, even if the insulating layer 3 contacts the inner surface 1b of the waveguide tube 1, it is possible to ensure that the outer circumferential surface 22a of the second shape 22 is separated from the inner surface 1b of the waveguide tube 1. If the insulating layer 3 is provided, even if the first conductor 20 and the waveguide tube 1 contact when the stub tuner 2 is inserted into the waveguide tube 1, the first conductor 20 and the waveguide tube 1 can be prevented from electrically contacting each other. Accordingly, the assembling process can be simplified. The insulating layer 3 may be any component as long as such component exhibits an electrically insulating effect. Examples of the insulating layer 3 include attachment of an insulating sheet having an adhesive.

### Second Embodiment

A stub tuner of a second embodiment will be described. Components same as those of the first embodiment are labeled with the same reference symbols, and the descriptions thereof will be omitted. As shown in FIG. 2, the stub tuner 2 of the second embodiment is inserted into a circular waveguide tube 101 in which a tube cross-section is circular. In the first embodiment, the second shape 22 is an elongated member with a U-shaped cross-section. However, in the second embodiment, a second shape 122 is in a cylindrical shape. A first conductor 120 (a first shape 121 and the second shape 122) is formed to be line symmetric with the conductor shaft 23 as an axis of symmetry. In the first conductor 120, in any cross-section passing through the conductor shaft 23, the first shape 121 and the second shape 122 are formed with a U-shaped cross-section. The support member 124 is formed in a disc shape in accordance with the inner circumferential surface of the circular waveguide tube 101. Other than the above, the second embodiment is the same as the first embodiment.

According to the above, in the first and second embodiments shown in FIGS. 1 to 10, a stub tuner 2 may include a first conductor (20, 120) and a conductor shaft 23. The first conductor (20, 120) is inserted from an opening 10 of a waveguide tube (1, 101) transmitting high frequency waves to a tube axial direction inner side AD1 and includes a first shape (21, 121) and a second shape (22, 122). The first shape (21, 121) is a plate shape extending in a direction intersecting with the tube axial direction AD in the waveguide tube. The second shape (22, 122) is a plate shape extending along the tube axial direction AD from a tube axial direction outer end of the first shape toward a tube axial direction outer side AD2. An outer circumferential surface 22a of the second shape is separated from an inner surface 1b of the waveguide tube 1, and an electrical length EL2 along the tube axial direction AD on the outer circumferential surface 22a of the second shape is ¼ of a wavelength λ of the high frequency waves. The conductor shaft 23 has a rod shape, is electrically connected to the waveguide tube, supports the first conductor, and extends in the tube axial direction AD.

In this way, since the outer circumferential surface 22a of the second shape (22, 122) is separated from the inner surface 1b of the waveguide tube (1, 101), the transmission path can be considered as equivalent to the transmission path T1 with an open end. In addition, since the electrical length EL2 along the tube axial direction AD on the outer circumferential surface 22a of the second end (22, 122) is ¼ of the wavelength λ of the high frequency waves, the oscillating electric field E generated in the waveguide tube (1, 101) becomes an antinode at the axial direction outer end P2 on the outer circumferential surface 22a of the second shape (22, 122). The oscillating electric field E generated in the waveguide tube (1, 101) becomes a node at the axial direction inner end P1 on the outer circumferential surface 22a of the second shape (22, 122). Since the node portion of the oscillating electric field E is arranged at the inlet of the gap between the second shape (22, 122) and the inner surface 1b of the waveguide tube (1, 101), the radio waves entering between the second shape (22, 122) and the inner surface of the waveguide tube (1, 101) can be significantly suppressed, and radio wave leakage as well as discharge between the second shape (22, 122) and the waveguide tube (1, 101) can be prevented.

In addition, since the second shape (22, 122) is separated from the inner surface 1b of the waveguide tube (1, 101), the outer diameter of the first conductor (20, 120) is smaller than the inner diameter of the waveguide tube, and, compared with a configuration in which the inner diameter of the waveguide tube and the outer diameter of the first conductor are the same, the first conductor (20, 120) can be moved with a smaller operation force during position adjustment. Moreover, the generation of metal powder due to contact between the first conductor (20, 120) and the waveguide tube (1, 101) can be reduced or prevented, and it is possible to suppress a failure.

Although the disclosure is not particularly limited, according to the first and second embodiments shown in FIGS. 1 to 10, it may also be that in the first conductor (20, 120), a distance D2 between an inner circumferential surface 22b of the second shape (22, 122) and an outer circumferential surface 23a of the conductor shaft 23 is greater than a distance D1 between the outer circumferential surface 22a of the second shape (22, 122) and an inner surface 1b of the waveguide tube (1, 101).

According to such configuration, by reducing the electric field between the inner circumferential surface 22b of the second shape (22, 122) and the outer circumferential surface 23a of the conductor shaft 23, the electrical field difference with respect to the inner surface 1b of the waveguide tube (1, 101), which occurs on the outer circumferential surface 22a of the second shape (22, 122), acts strongly, and the performance as a short stub is facilitated. In addition, it is possible to suppress the occurrence of an anomaly that discharge occurs between the inner circumferential surface 22b of the second shape (22, 122) and the outer circumferential surface 23a of the conductor shaft 23.

Although the disclosure is not particularly limited, according to the first and second embodiments shown in FIGS. 1 to 10, it may also be that the stub tuner includes a support member (24, 124) provided at the conductor shaft 23 on a side of the opening 10 of the waveguide tube (1, 101) with respect to the first conductor (20, 120), contacting an inner surface 1b of the waveguide tube to pass through the conductor shaft 23 to support the first conductor.

According to the configuration, since the position of the first conductor (20, 120) in the tube axial direction AD can be changed while the support member (24, 124) is brought into contact with the inner surface 1b of the waveguide tube (1, 101), it is possible facilitate the operability.

Although the disclosure is not particularly limited, according to the first and second embodiments shown in FIGS. 1 to 10, it may also be that in a cross-section where the first conductor (20, 120) is present, the conductor shaft 23 is located at a center of a pair of the second shapes (22, 122), the support member (24, 124) is formed by a conductor and electrically connected to the conductor tube (1, 101), in the first conductor (20, 120) and the conductor shaft 23, an electrical length EL3 along component surfaces from an intersection point P3 with the support member (24, 124) on an outer circumferential surface 23a of the conductor shaft 23 to a tube axial direction outer end P6 of an inner circumferential surface 22b of the second shape (22, 122) through an intersection point P4 with a tube axial direction outer side surface 21b of the first shape (21, 121) on an outer circumferential surface 23a of the conductor shaft 23 and an intersection point P5 with the inner circumferential surface 22b of the second shape (22, 122) on the tube axial direction outer side surface 21b of the first shape (21, 121) is ¾ of the wavelength λ of the high frequency waves.

According to the configuration, since the support member (24, 124) is a conductor and electrically connected to the waveguide tube (1, 101), the oscillating electric field E becomes a node at the intersection point P3. With the transmission path T2 formed by the metal skin on the inner circumferential side of the second shape from the intersection point P3 to the intersection point P6 via the intersection points P4 and P5, the oscillating electric field E becomes an antinode at the tube axial direction outer end P6 of the inner circumferential surface 22b of the second shape (22, 122). Meanwhile, the electrical length EL2 along the tube axial direction AD on the outer circumferential surface 22a of the second shape (22, 122) is ¼ of the wavelength λ of the high frequency waves, and, with the transmission path T1 formed between the outer circumferential surface 22a of the second shape (22, 122) and the inner surface 1b of the waveguide tube (1, 101), the oscillating electric field E at the tube axial direction outer end P2 of the outer circumferential surface of the second shape becomes an antinode. By doing so, in each of the transmission paths (T1, T2) formed on the outer circumferential side and the inner circumferential side of the second shape (22, 122), the oscillating electric field E becomes an antinode at the tube axial direction outer end (P2, P6) of the second shape. As a result, the oscillating electric field E becoming a node in the tube axial direction inner end P1 on the outer circumferential surface 22a of the second shape (22, 122) can be facilitated, and it is possible to facilitate a radio wave shielding effect.

Although the disclosure is not particularly limited, according to the embodiment shown in FIG. 8, it may also be that an insulating layer 3 is provided on the outer circumferential surface 22a of the second shape 22.

With the configuration, even if the second shape 22 mechanically contact the inner surface 1b of the waveguide tube 1 when the first conductor 20 is inserted into the waveguide tube 1, it is possible to suppress collapse of the electrical length EL2, as the second shape 22 and the waveguide tube 1 are not in electric contact due to the insulating layer 3.

Although the disclosure is not particularly limited, according to the first embodiment shown in FIGS. 1 to 9, it may also be that the waveguide tube 1 is a rectangular waveguide tube in which a tube cross-sectional surface has long sides 11 and short sides 12, the second shape 22 is a shape of a pair of plates respectively extending from a tube axial direction outer end of the first shape 21 toward the opening 10 along the tube axial direction AD, and the shape of the pair of plates faces at least a portion of the inner surface 1b on the long sides 11 of the waveguide tube 1.

According to the configuration, it is possible to suitably suppress leakage of the high frequency waves in the rectangular waveguide tube 1. In addition, it is not required that the entire inner surface on the long sides 11 faces second shape 2, and the design and adjustment are simplified.

Although the disclosure is not particularly limited, according to the first embodiment shown in FIGS. 1 to 9, it may also be that in a cross-section passing through centers 11s of the long sides 11 and a tube axis A1, the first conductor 20 is in a U shape.

According to the configuration, since the portion passing through the centers 11s of the long sides 11 and the tube axis A1 in the rectangular waveguide tube 1 is a portion with the maximum electric field, it is possible to reliably exhibit the effects.

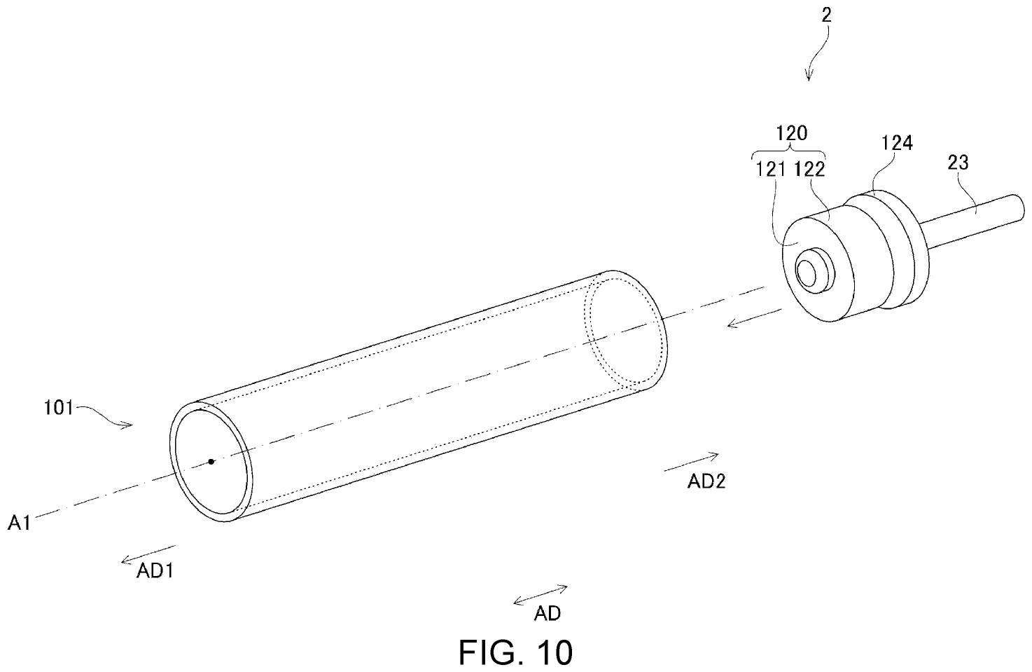

Although the disclosure is not particularly limited, according to the second embodiment shown in FIG. 10, it may also be that the waveguide tube is a circular waveguide tube 101 in which a tube cross-sectional surface is circular, and the second shape 122 is formed to be line symmetric with the conductor shaft 23 as an axis of symmetry.

According to the configuration, in the circular waveguide tube 101, the electric field is at the maximum along any tube axial direction passing through the tube axis A1. Therefore, it is possible to reliably exhibit the effects.

Although the embodiments of the disclosure have been described above based on the drawings, it should be considered that the specific configurations are not limited to these embodiments. The scope of the disclosure is indicated not only by the description of the above embodiments but also by the scope of claims, and includes all modifications within the meaning and scope equivalent to the scope of claims.

It is possible to adopt the structure adopted in each of the above embodiments in any other embodiment.

The specific configuration of each part is not limited to the above embodiments, and various modifications are possible without departing from the scope of the disclosure.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processor. A processor can be a microprocessor, but in the alternative, the processor can be a controller, microcontroller, or state machine, combinations of the same, or the like. A processor can include electrical circuitry configured to process computer-executable instructions. In another embodiment, a processor includes an application specific integrated circuit (ASIC), a field programmable gate array (FPGA) or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface”. The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the terms “attached,” “connected,” “mated,” and other such relational terms should be construed, unless otherwise noted, to include removable, moveable, fixed, adjustable, and/or releasable connections or attachments. The connections/attachments can include direct connections and/or connections having intermediate structure between the two components discussed.

Numbers preceded by a term such as “approximately”, “about”, and “substantially” as used herein include the recited numbers, and also represent an amount close to the stated amount that still performs a desired function or achieves a desired result. For example, the terms “approximately”, “about”, and “substantially” may refer to an amount that is within less than 10% of the stated amount. Features of embodiments disclosed herein preceded by a term such as “approximately”, “about”, and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A stub tuner, comprising:
a first conductor, inserted from an opening of a waveguide tube transmitting high frequency waves to a tube axial direction inner side and comprising: a first shape, which is a plate shape extending in a direction intersecting with the tube axial direction in the waveguide tube; and a second shape, which is a plate shape extending along the tube axial direction from a tube axial direction outer end of the first shape toward a tube axial direction outer side, wherein an outer circumferential surface of the second shape is separated from an inner surface of the waveguide tube, and an electrical length along the tube axial direction on the outer circumferential surface of the second shape is ¼ of a wavelength of the high frequency waves; and
a conductor shaft, having a rod shape, electrically connected to the waveguide tube, supporting the first conductor, and extending in the tube axial direction.

2. The stub tuner as claimed in claim 1, wherein in the first conductor, a distance between an inner circumferential surface of the second shape and an outer circumferential surface of the conductor shaft is greater than a distance between the outer circumferential surface of the second shape and the inner surface of the waveguide tube.

3. The stub tuner as claimed in claim 1, comprising a support member provided at the conductor shaft on an opening side of the waveguide tube with respect to the first conductor, and contacting an inner surface of the waveguide tube to pass through the conductor shaft to support the first conductor.

4. The stub tuner as claimed in claim 3, wherein in a cross-section where the first conductor is present, the conductor shaft is located at a center of a pair of the second shapes,
the support member is formed by a conductor and electrically connected to the conductor tube,
in the first conductor and the conductor shaft, an electrical length along component surfaces from an intersection point P3 with the support member on an outer circumferential surface of the conductor shaft to a tube axial direction outer end P6 of an inner circumferential surface of the second shape through an intersection point P4 with a tube axial direction outer side surface of the first shape on an outer circumferential surface of the conductor shaft and an intersection point P5 with the inner circumferential surface of the second shape on the tube axial direction outer side surface of the first shape is ¾ of the wavelength of the high frequency waves.

5. The stub tuner as claimed in claim 1, wherein an insulating layer is provided on the outer circumferential surface of the second shape.

6. The stub tuner as claimed in claim 1, wherein the waveguide tube is a rectangular waveguide tube in which a tube cross-sectional surface has long sides and short sides,
the second shape is a shape of a pair of plates respectively extending from a tube axial direction outer end of the first shape toward the opening along the tube axial direction, and the shape of the pair of plates faces at least a portion of the inner surface on the long sides of the waveguide tube.

7. The stub tuner as claimed in claim 6, wherein in a cross-section passing through central portions of the long sides and a tube axis, the first conductor is in a U shape.

8. The stub tuner as claimed in claim 1, wherein the waveguide tube is a circular waveguide tube in which a tube cross-sectional surface is circular, and
the second shape is formed to be line symmetric with the conductor shaft as an axis of symmetry.
